(19) United States
(12) Patent Application Publication
(10) Pub. No.: US 2018/0069437 A1
(43) Pub. Date: Mar. 8, 2018

(54) METHOD AND SYSTEM FOR AUTOMATICALLY CHARGING ROBOT BASED ON ULTRASONIC WAVE

(71) Applicant: Nanjing AvatarMind Robot Technology Co., Ltd., Nanjing (CN)

(72) Inventors: Tingliang LI, Nanjing (CN); Zhen LI, Nanjing (CN)

(21) Appl. No.: 15/806,278

(22) Filed: Nov. 7, 2017

Related U.S. Application Data
(63) Continuation of application No. PCT/CN2017/098795, filed on Aug. 24, 2017.

(30) Foreign Application Priority Data
Sep. 8, 2016 (CN) 201610810649.9

(51) Int. Cl. H02J 50/15; B25J 19/00; B60L 11/18; G05D 1/02; H02J 7/02; H02J 50/90

(52) U.S. Cl. CPC H02J 50/15; B25J 19/005; B60L 11/182; H02J 50/90; B60L 11/1861; H02J 7/025; G05D 1/0225

(57) ABSTRACT

In a method and system for automatically charging a robot based on ultrasonic wave according to the present disclosure, by configuring an ultrasonic transmitting module and a wireless communication module on a charging mount, and configuring two ultrasonic receiving modules and a wireless communication module on the robot, the robot calculates a distance and deflection of the robot relative to the charging mount according to signal strengths of received ultrasonic signals and a strength difference therebetween, and completes automatic tracing of the robot in combination with a motion control system and a posture adjustment strategy to automatically charge the robot. The method and system according to the present disclosure have a low cost, are suitable for a complicated application environment, and improve intelligence of the robots.

This application is an US national stage application of the international patent application PCT/CN2017/098795, filed on Aug. 24, 2017, which is based upon and claims priority of Chinese Patent Application No. 201610810649.9, filed before Chinese Patent Office on Sep. 8, 2016 and entitled “METHOD AND SYSTEM FOR AUTOMATICALLY CHARGING ROBOT BASED ON ULTRASONIC WAVE”, the entire contents of which are incorporated herein by reference.

### TECHNICAL FIELD

The present disclosure relates to the field of robot-assistant technologies, and in particular, relates to a method and system for automatically charging a robot based on ultrasonic wave.

### BACKGROUND

Two methods for automatically charging a robot are currently available. In one method, a charging mount guides a robot to trace to the charging mount, the charging mount is configured with a signal transmitter, and the robot is configured with a signal receiver. The generally-used method is infrared ranging-based positioning, but this method may cause defects. Since infrared signals are transmitted and received in a point-to-point mode, an infrared transmitter and an infrared receiver need to be arranged in the same horizontal plane. It is hard to implement infrared positioning in a complicated uneven application environment. In addition, dust fragments may cause interference to receiving of the infrared ray on the robot, and the infrared ray is simply subject to interference caused by an indoor fluorescent lamp during the transmission course thereof. In the other method, by using laser modeling or camera identification, the robot positions the charger, and in combination of a motion control system of the robot, the robot is enabled to automatically move to the charging mount, such that the robot is automatically charged. However, the implementation of this solution is very difficult, and the cost is high.

### SUMMARY

The problem to be solved in the present disclosure is to provide a method and system for automatically charging a robot based on ultrasonic wave. The method and system have a low implementation cost, and are suitable for a complicated environment.

To achieve the above objectives, the present disclosure employs the following technical solutions:

A method for automatically charging a robot based on ultrasonic wave includes the following steps:

detecting, by the robot, a battery level, and enabling a charging mount to send an ultrasonic pulse signal via wireless communication if the battery level is low;

receiving, by the robot, an ultrasonic pulse signal sent by an ultrasonic transmitting module by using a first ultrasonic receiving module and a second ultrasonic receiving module that are configured on the robot;

calculating, by the robot, a distance and deflection of the robot relative to the charging mount according to signal strengths of the ultrasonic pulse signals respectively received by the first ultrasonic receiving module and the second ultrasonic receiving module and a strength difference therebetween;

controlling, by a motion control system of the robot, the robot to approach the charging mount according to the distance and deflection; and

interconnecting, by the robot, with the charging mount for charging when the robot moves to the front of the charging mount or the distance and deflection are less than predetermined thresholds.

Further, the calculating, by the robot, a distance and deflection of the robot relative to the charging mount:

converting the two ultrasonic pulse signals respectively received into digital signals by using an analog-to-digital conversion module, subjecting the two digital signals to fast Fourier transformation (FFT), acquiring a finite-length sequence x(n) by data windowing and directly obtaining a spectrum X(e^{jw}) by the FFT, taking a square of a spectrum amplitude, dividing the square by N, and by using a result as an estimation of an actual power spectrum S_{X}(e^{jw}) of x(n), calculating power spectrum intensities P_{L} and P_{R} of the left and right signals and an intensity difference P□ between the left and right signals, such that the deflection and range of the ultrasonic transmitting module of the charging mount relative to the two ultrasonic receiving module of the robot are calculated and that an approximate position of the robot relative to the charging mount is calculated using the following formulae:

$$X ( {e}^{jw} ) = {\sum }_{n = - ∞}^{+ ∞} {x}_{n} {e}^{- jnw} = {\sum }_{n = 0}^{N - 1} {x}_{n} {e}^{- jnw}$$

$${S}_{x} ( {e}^{jw} ) = \frac{1}{N} {\vert X ( {e}^{jw} ) \vert}^{2}$$

Further, in the course of receiving the ultrasonic pulse signal sent by the ultrasonic transmitting module on the charging mount by the robot, if the robot rotates in place by 180 degrees but still fails to receive the ultrasonic pulse signal sent by the ultrasonic transmitting module on the charging mount, the robot starts wall movement in a clockwise direction.

The system for automatically charging a robot based on ultrasonic wave includes: a robot control system, a robot power management system, a robot motion control system, a robot positioning and ultrasonic distance and deflection calculation control panel, a first ultrasonic receiving module, a second ultrasonic receiving module, and an analog-to-digital conversion module (an AC-DC module), an ultrasonic transmitting module and a wireless communication module that are configured on the charging mount.

Further, the system for automatically charging a robot based on ultrasonic wave further includes: a charging management unit, a battery voltage and current sampling unit and a battery unit.

Further, the system for automatically charging a robot based on ultrasonic wave further includes: a servo motor control unit and a robot chassis motor speed and deflection sampling unit.

In the method and system for automatically charging a robot based on ultrasonic wave according to the present disclosure, by configuring an ultrasonic transmitting module and a wireless communication module on a charging mount, and configuring two ultrasonic receiving modules and a wireless communication module on the robot, the robot calculates a distance and deflection of the robot relative to the charging mount according to signal strengths of received ultrasonic signals and a strength difference therebetween, and completes automatic tracing of the robot in combination with a motion control system and a posture adjustment strategy to automatically charge the robot. The method and system according to the present disclosure have a low cost, are suitable for a complicated application environment, and improve intelligence of the robots.

### BRIEF DESCRIPTION OF THE DRAWINGS

FIG. 1 is a structural diagram of a system for automatically charging a robot according to the present disclosure;

FIG. 2 is a schematic modular diagram of a robot system according to the present disclosure;

FIG. 3 is a schematic modular diagram of a charging mount system according to the present disclosure;

FIG. 4 is a flowchart of a method for automatically charging a robot according to an embodiment of the present disclosure;

FIG. 5 is a schematic diagram of ultrasonic transmission intensities;

FIG. 6 is a schematic diagram of ultrasonic receiving spectrum amplitudes;

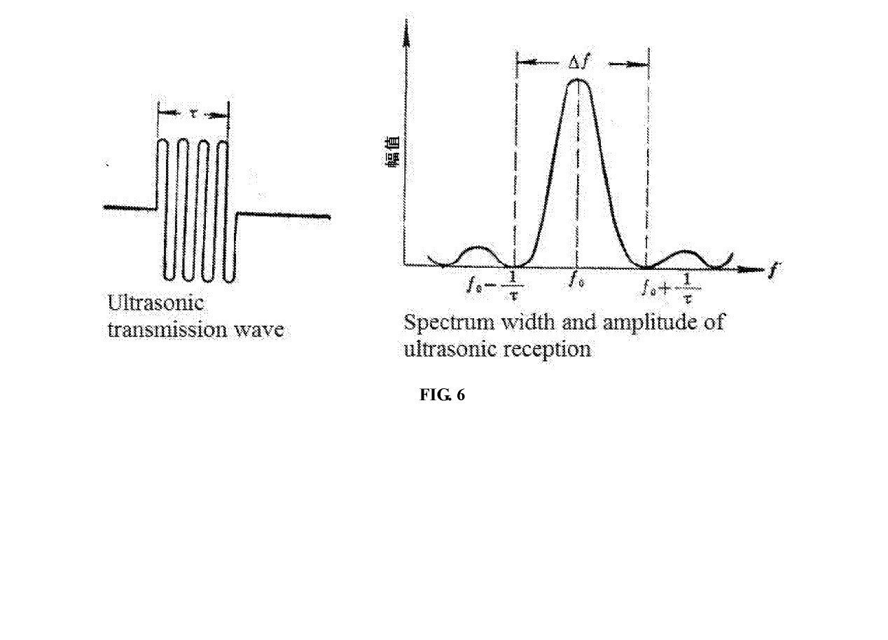

FIG. 7 is schematic diagram illustrating an electrical principle of an ultrasonic transmitting module;

FIG. 8 is a schematic diagram illustrating an electrical principle of an ultrasonic receiving module; and

FIG. 9 is a schematic diagram illustrating an electrical principle of an ultrasonic transmitting/receiving control unit.

### DETAILED DESCRIPTION

Hereinafter a method and system for automatically charging a robot based on ultrasonic wave according to the present disclosure are described in retail with reference to the accompanying drawings.

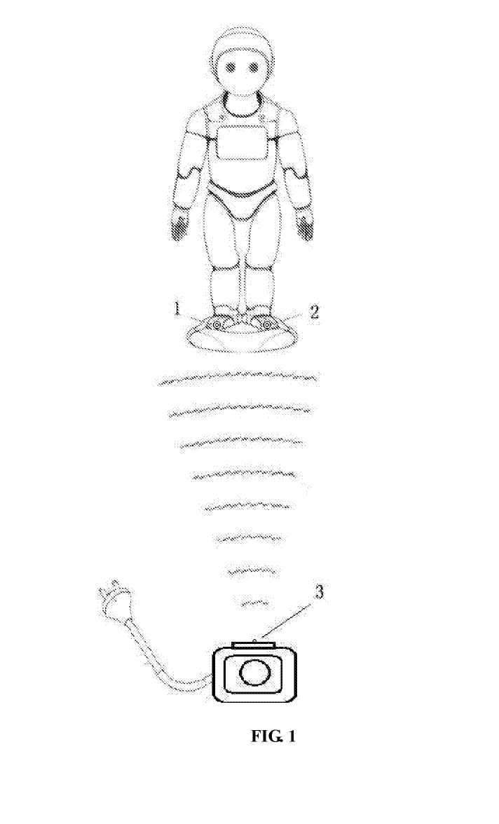

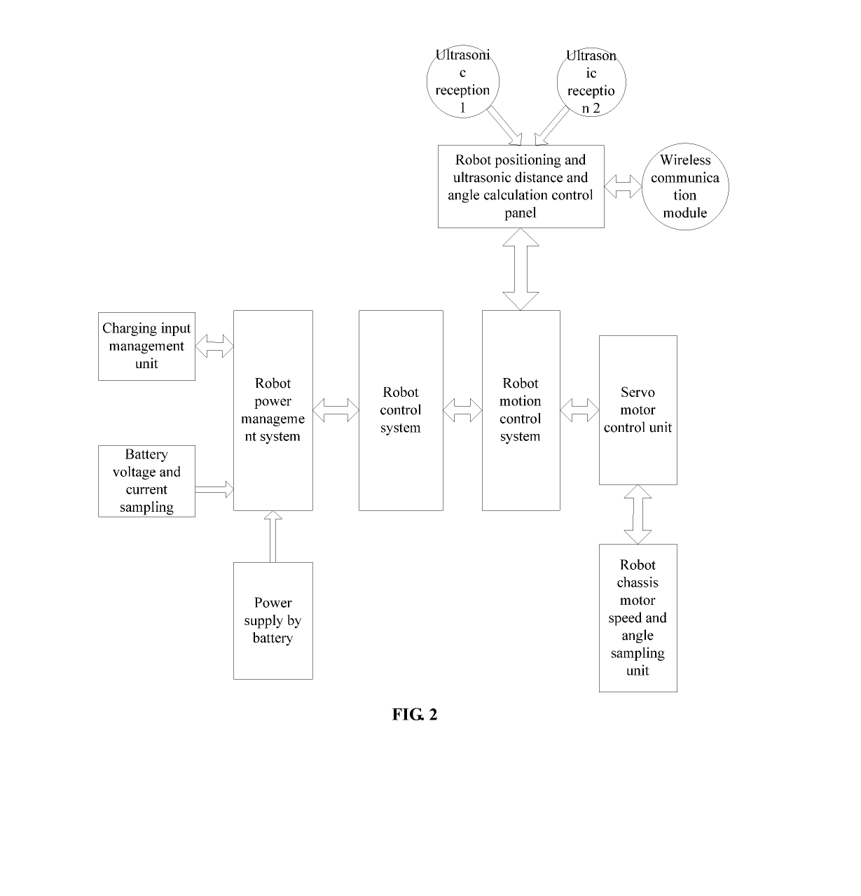

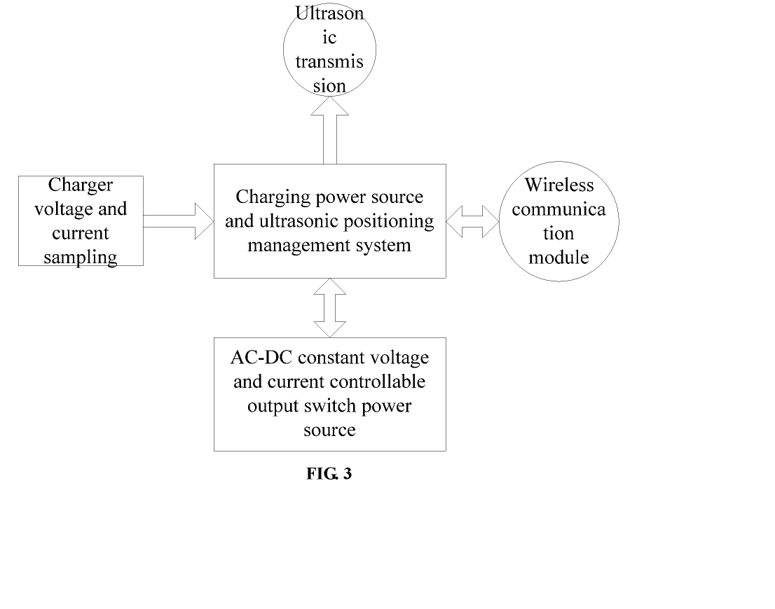

As illustrated in FIG. 1 to FIG. 3, a system for automatically charging a robot based on ultrasonic wave includes: a robot control system, a robot power management system, a robot motion control system, a robot positioning and ultrasonic distance and deflection calculation control panel, a first ultrasonic receiving module 1, a second ultrasonic receiving module 2, and an analog-to-digital conversion module (an AC-DC module), an ultrasonic transmitting module 3 and a wireless communication module that are configured on the charging mount. The system further includes: a charging management unit, a battery voltage and current sampling unit, a battery unit, a servo motor control unit, and a robot chassis speed and deflection sampling unit.

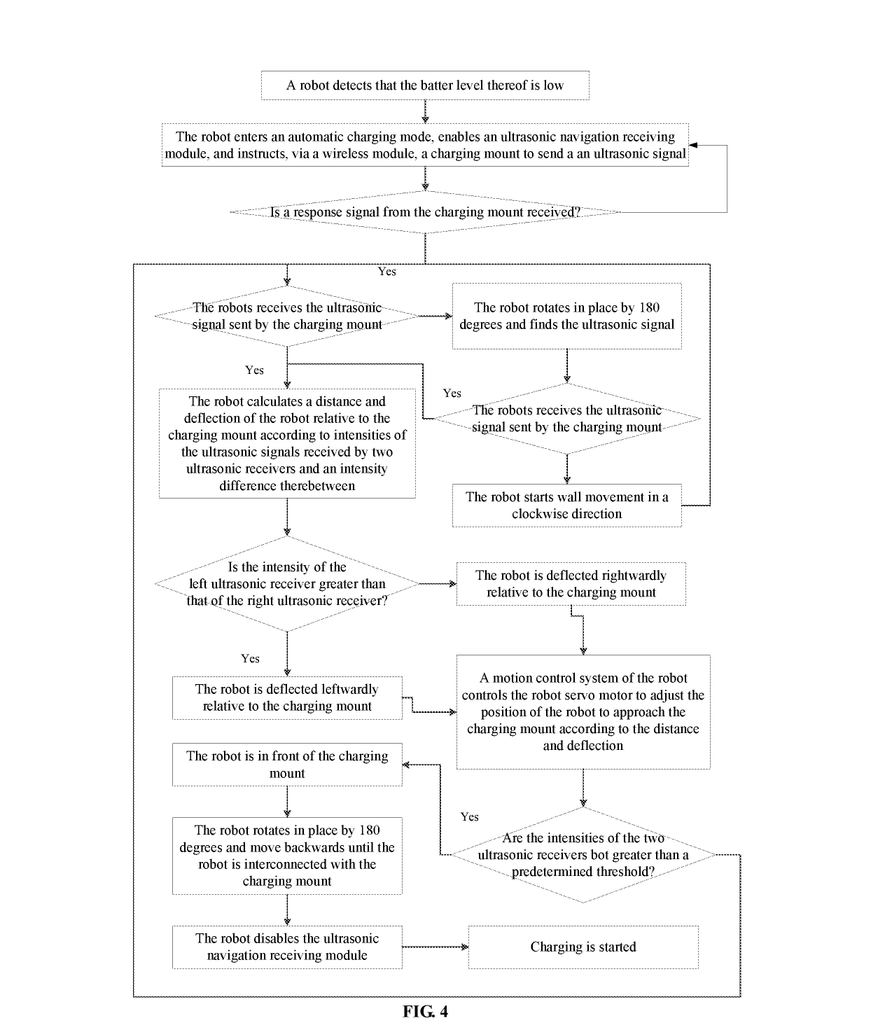

As illustrated in FIG. 4, a method for automatically charging a robot based on ultrasonic wave includes the following steps:

detecting, by the robot, a battery level, and enabling a charging mount to send an ultrasonic pulse signal via wireless communication if the battery level is low;

receiving, by the robot, an ultrasonic pulse signal sent by an ultrasonic transmitting module by using a first ultrasonic receiving module and a second ultrasonic receiving module that are configured on the robot;

calculating, by the robot, a distance and deflection of the robot relative to the charging mount according to signal strengths of the ultrasonic pulse signals respectively received by the first ultrasonic receiving module and the second ultrasonic receiving module and a strength difference therebetween;

controlling, by a motion control system of the robot, the robot to approach the charging mount according to the distance and deflection; and

interconnecting, by the robot, with the charging mount for charging when the robot moves to the front of the charging mount or the distance and deflection are less than predetermined thresholds.

Specifically, after a robot power management system detects that the battery level is low, that is, when it is detected that the battery is less than a predetermined threshold, the robot power management system deems that the battery is low, reports to a robot control system, and the robot control system enters an automatic charging mode, and sends an instruction to instruct a robot motion control system to get ready to enter an automatic charging tracing state. The robot motion control system enables the ultrasonic receiving control unit, and enables, in a wireless communication manner, the charging mount to transmit an ultrasonic signal.

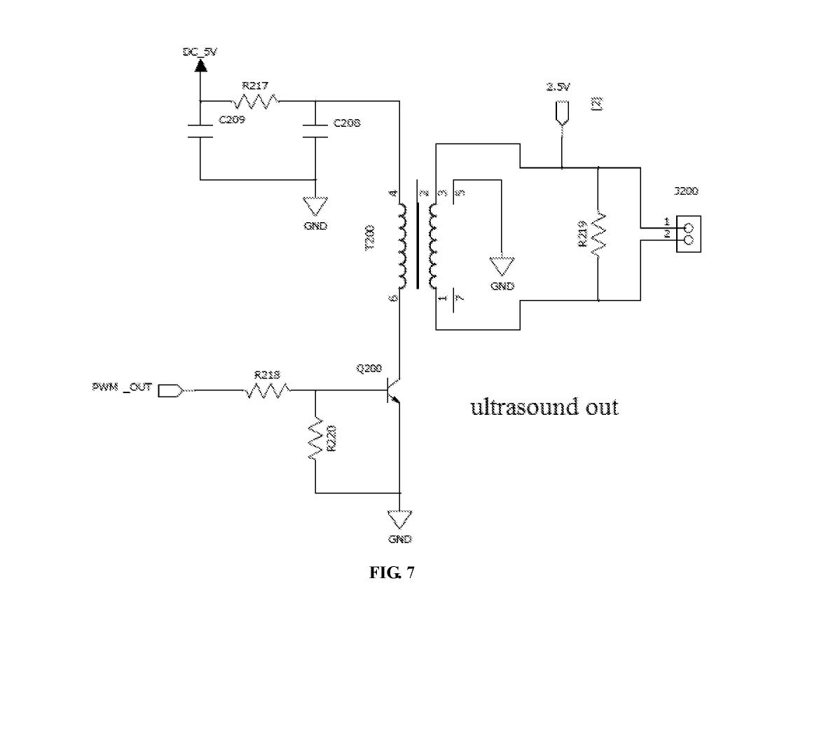

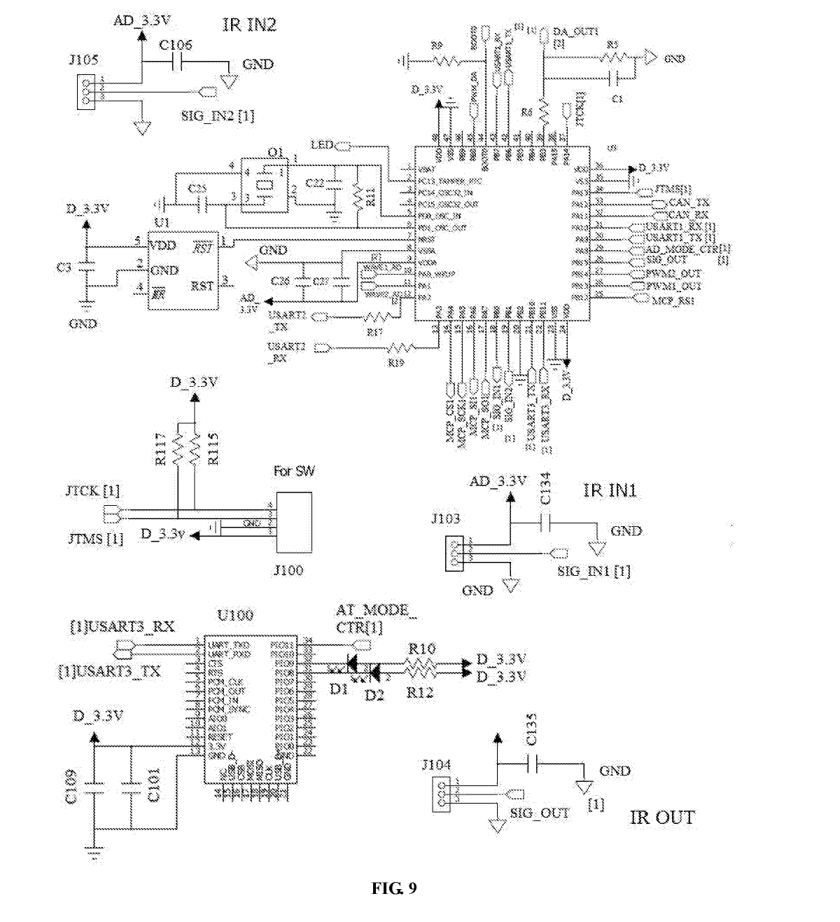

After the recharging mount receives a wireless request signal sent by the robot, FIG. 9 illustrates an electrical principle of an ultrasonic transmitting/receiving control unit, which includes a central control unit, a wireless transceiver module, an ultrasonic transmitting module 3 and an AC/DC charging power source. FIG. 7 illustrates an electrical principle of an ultrasonic transmitting module. The ultrasonic transmitting module 3 sends a fan-shaped acoustic wave, and starts to guide the robot to approach the charging mount.

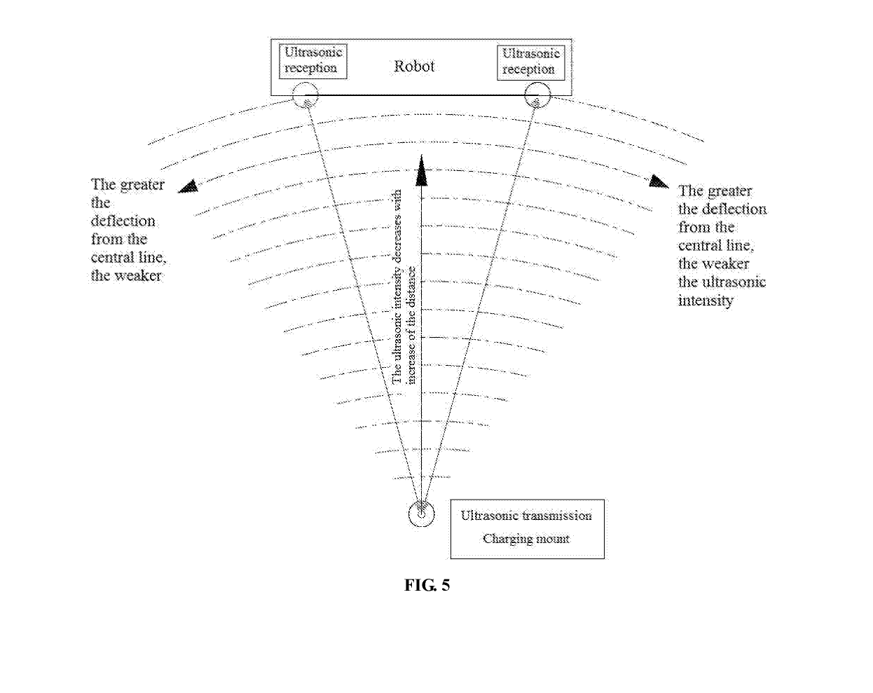

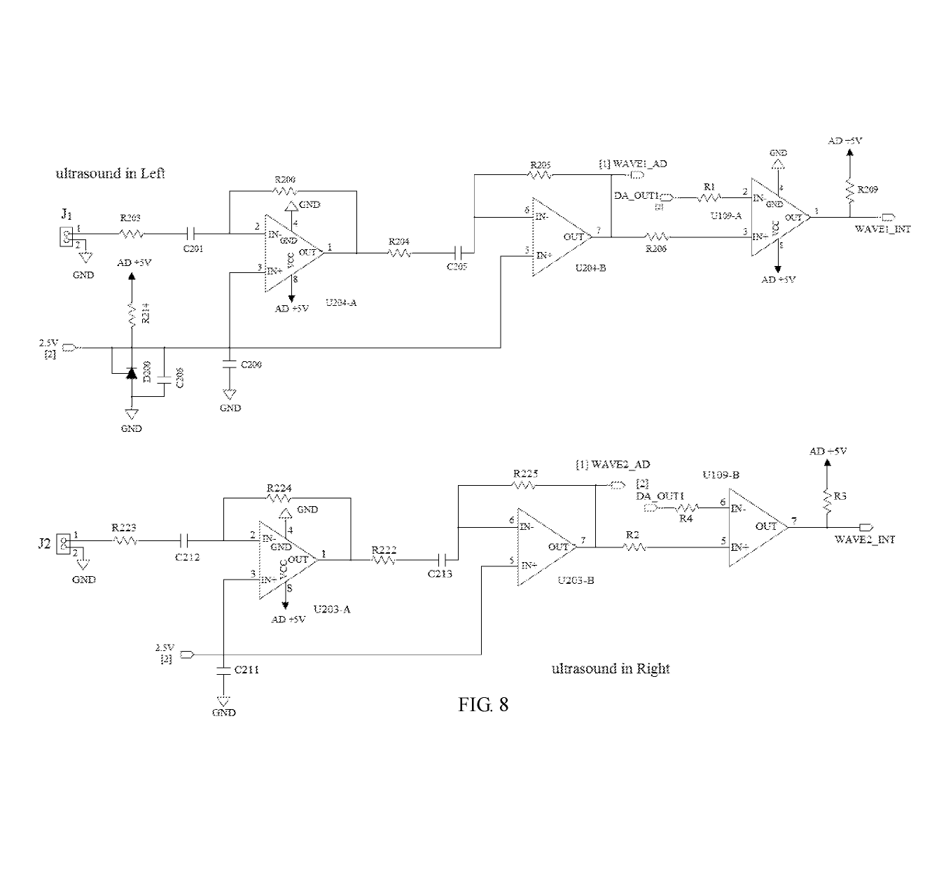

FIG. 8 is a schematic diagram illustrating an electrical principle of an ultrasonic receiving module. After receiving an ultrasonic pulse signal, a robot calculates a distance and deflection of the robot relative to a charging mount according to intensities of ultrasonic waves received by the first ultrasonic receiving module 1 and the second ultrasonic receiving module 2 and a strength difference therebetween. As illustrated in FIG. 5, the ultrasonic signals are strong or weak, the two ultrasonic pulse signals respectively received are converted into digital signals by using an analog-to-digital conversion module, the two digital signals is subjected to fast Fourier transformation (FFT), a finite-length sequence x(n) is acquired by data windowing and a spectrum X(e^{jw}) is directly acquired by the FFT, a square of a spectrum amplitude is taken, the square is divided by N, and by using a result as an estimation of an actual power spectrum S_{X}(e^{jw}) of x(n), power spectrum intensities P_{L} and P_{R} of the left and right signals and an intensity difference P□ between the left and right signals are calculated, such that the deflection and range of the ultrasonic transmitting module of the charging mount relative to the two ultrasonic receiving module of the robot are calculated and that an approximate position of the robot relative to the charging mount is calculated using the following formulae:

$$X ( {e}^{jw} ) = {\sum }_{n = - ∞}^{+ ∞} {x}_{n} {e}^{- jnw} = {\sum }_{n = 0}^{N - 1} {x}_{n} {e}^{- jnw}$$

$${S}_{x} ( {e}^{jw} ) = \frac{1}{N} {\vert X ( {e}^{jw} ) \vert}^{2}$$

When the robot moves to the front of the charging mount or the distance is less than a predetermined threshold, the robot rotates in place by 180 degrees, and runs backwards to interconnect with the charging mount; when a robot power management system detects that a charging voltage is accessed, it is deemed that the robot has been reliably interconnected with the charging mount. In this case, the charging mount disables the ultrasonic pulse signal, and the robot also disables an ultrasonic receiving signal; and when the charging is finished, the charging mount disables charging power output, and an entire automatic charging process is completed.

The present disclosure may be applied in various scenarios. Described above are merely preferred embodiments illustrating the present disclosure. It should be noted that persons of ordinary skill in the art would derive several improvements to the present disclosure without departing from the principle of the present disclosure, and these improvements shall be considered as falling within the protection scope of the present disclosure.

What is claimed is:

1. A method for automatically charging a robot based on ultrasonic wave, comprising the following steps:
detecting, by the robot, a battery level, and enabling a charging mount to send an ultrasonic pulse signal via wireless communication if the battery level is less than a predetermined threshold;
receiving, by the robot, an ultrasonic pulse signal sent by an ultrasonic transmitting module by using a first ultrasonic receiving module and a second ultrasonic receiving module that are configured on the robot;
calculating, by the robot, a distance and deflection of the robot relative to the charging mount according to the ultrasonic pulse signals respectively received by the first ultrasonic receiving module and the second ultrasonic receiving module;
approaching, by the robot, the charging mount according to the distance and deflection; and
interconnecting, by the robot, with the charging mount for charging when the robot moves to the front of the charging mount or the distance and deflection are less than predetermined thresholds.

2. The method for automatically charging a robot based on ultrasonic wave according to claim 1, wherein the ultrasonic pulse signals respectively received by the first ultrasonic receiving module and the second ultrasonic receiving module further comprises:
signal strengths of the ultrasonic pulse signals respectively received by the first ultrasonic receiving module and the second ultrasonic receiving module, and a strength difference between the signal strengths of the ultrasonic pulse signals respectively received by the first ultrasonic receiving module and the second ultrasonic receiving module.

3. The method for automatically charging a robot based on ultrasonic wave according to claim 2, wherein the calculating a distance and deflection of the robot relative to the charging mount comprises:
converting the two ultrasonic pulse signals respectively received by the first ultrasonic receiving module and the second ultrasonic receiving module into digital signals by using an analog-to-digital conversion module, subjecting the two digital signals to fast Fourier transformation (FFT), acquiring a finite-length sequence x(n) by data windowing and directly obtaining a spectrum X(e^{jw}) by the FFT, taking a square of a spectrum amplitude, dividing the square by N, and by using a result as an estimation of an actual power spectrum S_{X}(e^{jw}) of x(n), calculating power spectrum intensities P_{L} and P_{R} of the left and right signals and an intensity difference P□ between the left and right signals, such that the deflection and range of the ultrasonic transmitting module of the charging mount relative to the two ultrasonic receiving module of the robot are calculated and that an approximate position of the robot relative to the charging mount is calculated using the following formulae:
$$X ( {e}^{jw} ) = {\sum }_{n = - ∞}^{+ ∞} {x}_{n} {e}^{- jnw} = {\sum }_{n = 0}^{N - 1} {x}_{n} {e}^{- jnw} ;$$
$${S}_{x} ( {e}^{jw} ) = \frac{1}{N} {\vert X ( {e}^{jw} ) \vert}^{2} .$$

4. The method for automatically charging a robot based on ultrasonic wave according to claim 1, wherein the receiving, by the robot, an ultrasonic pulse signal sent by an ultrasonic transmitting module by using a first ultrasonic receiving module and a second ultrasonic receiving module comprises:
upon receiving a response signal from the charging mount, initially judging, by the robot, whether the ultrasonic pulse signal sent by the charging mount is received; and
if the ultrasonic pulse signal is not received, rotating in place, by the robot, by 180 degrees to find the ultrasonic pulse signal.

5. The method for automatically charging a robot based on ultrasonic wave according to claim 4, wherein the receiving, by the robot, an ultrasonic pulse signal sent by an ultrasonic transmitting module by using a first ultrasonic receiving module and a second ultrasonic receiving module further comprises:
upon rotating in place by 180 degrees, judging again, by the robot, whether the ultrasonic pulse signal sent by the charging mount is received; and
if the ultrasonic pulse signal is still not received after the robot rotates in place by 180 degrees, starting wall movement in a clockwise direction by the robot and returning to the initially judging whether the ultrasonic pulse signal sent by the charging mount is received.

6. The method for automatically charging a robot based on ultrasonic wave according to claim 1, the interconnecting, by the robot, with the charging mount comprises:
rotating in place, by the robot, by 180 degrees, moving backwards until the robot is interconnected with the charging mount.

7. A system for automatically charging a robot based on ultrasonic wave, comprising: a robot and a charging mount; wherein
the robot comprises:
a robot control system, a robot power management system, a robot motion control system, a robot positioning and ultrasonic distance and deflection calculation control panel, a first ultrasonic receiving module and a second ultrasonic receiving module; and
the charging mount comprises:
an analog-to-digital conversion module, an ultrasonic transmitting module and a wireless communication module.

8. The system for automatically charging a robot based on ultrasonic wave according to claim 7, wherein the robot further comprises:
a charging management unit, a battery voltage and current sampling unit and a battery unit.

9. The system for automatically charging a robot based on ultrasonic wave according to claim 7, wherein the robot further comprises:
a servo motor control unit and a robot chassis motor speed and deflection sampling unit.

10. The system for automatically charging a robot based on ultrasonic wave according to claim 7, wherein the charging mount further comprises:
a charger voltage and current sampling unit.
